(19) United States
(12) Patent Application Publication
(10) Pub. No.: US 2026/0212000 A1
(43) Pub. Date: Jul. 23, 2026

(54) ELECTRONIC DEVICE FOR EXECUTING TRUSTED APPLICATION IN TRUSTED EXECUTION ENVIRONMENT AND METHOD AND STORAGE MEDIUM THEREOF

(71) Applicant: Samsung Electronics Co., Ltd., Suwon-si (KR)

(72) Inventors: Sojin AHN, Suwon-si (KR); Hyungchul JUNG, Suwon-si (KR); Jihyuk LIM, Suwon-si (KR)

(21) Appl. No.: 19/455,161

(22) Filed: Jan. 21, 2026

Related U.S. Application Data
(63) Continuation of application No. PCT/KR2026/000527, filed on Jan. 9, 2026.

(30) Foreign Application Priority Data
Jan. 22, 2025 (KR) 10-2025-0009421
Feb. 28, 2025 (KR) 10-2025-0026506

(51) Int. Cl. G06F 21/53

(52) U.S. Cl. CPC G06F 21/53; G06F 2221/033

(57) ABSTRACT

An electronic device is provided. The electronic device includes memory comprising one or more storage media, storing instructions; and one or more processors communicatively coupled to the memory, and the instructions that, when executed by the one or more processors individually or collectively, cause the electronic device to, identify an execution request for an application in a rich execution environment (REE), based on the execution request for the application, execute a first secure operating system (OS) with a first priority among a plurality of secure OSs, based on configuration information for the application including priorities of the plurality of secure OSs in which a plurality of trusted applications (TAs) related to the application are executable, execute, on the first secure OS, a first TA corresponding to the first secure OS among the plurality of TAs, based on an execution result of the first TA being execution failure, execute a second secure OS with a second priority among secure OSs other than the first secure OS among the plurality of secure OSs, execute, on the second secure OS, a second TA corresponding to the second secure OS among the plurality of TAs, and based on an execution result of the second TA being execution success, execute the application, wherein a TA includes an application being executed in a trusted execution environment (TEE), and wherein the plurality of secure OSs are executed in the TEE.

### CROSS-REFERENCE TO RELATED APPLICATION(S)

This application is a continuation application, claiming priority under 35 U.S.C. § 365 (c), of an International application No. PCT/KR2026/000527, filed on Jan. 9, 2026, which is based on and claims the benefit of a Korean patent application number 10-2025-0009421, filed on Jan. 22, 2025, in the Korean Intellectual Property Office, and of a Korean patent application number 10-2025-0026506, filed on Feb. 28, 2025, in the Korean Intellectual Property Office, the disclosure of each of which is incorporated by reference herein in its entirety.

### TECHNICAL FIELD

The disclosure relates to an electronic device for executing a trusted application (TA) in a trusted execution environment (TEE), and a method and storage medium thereof.

### BACKGROUND ART

A secure zone technology is a technology for providing a multi-execution environment (e.g., a normal environment and a secure environment) and is used in a processor (e.g., an application processor) to protect high-value code and data. The secure zone technology provides an efficient and system-wide approach to security using hardware-enforced isolation built in a central processing unit (CPU). The concepts of a secure zone (or a secure world or a trusted world) and a non-secure zone (or a non-secure world or a non-trusted world) in the secure zone technology are extended to encompass memory within a system on chip (SoC) (e.g., an application processor), software, bus transactions, interrupts, and peripheral devices.

This secure zone technology typically generates a trusted execution environment (TEE) by executing trusted booting and a trusted operating system (OS). The TEE is an independent application execution environment for performing an operation in which a relatively high-secure level which is higher than or equal to a threshold secure level is required within an electronic device. The TEE may be distinguished from a rich execution environment (REE), which is a typical application execution environment, in terms of hardware or software, and may load a secure operating system (OS) capable of executing a trusted application (TA). The TEE may be used for protecting an authentication mechanism, cryptography, mobile device management, payments, a key material, and digital rights management (DRM).

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic device for executing a trusted application (TA) in a trusted execution environment (TEE), and a method and storage medium thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory comprising one or more storage media, storing instructions, and one or more processors communicatively coupled to the memory, wherein the instructions that, when executed by the one or more processors individually or collectively, cause the electronic device to identify an execution request for an application in a rich execution environment (REE), based on the execution request for the application, execute a first secure operating system (OS) with a first priority among a plurality of secure OSs, based on configuration information for the application including priorities of the plurality of secure OSs in which a plurality of trusted applications (TAs) related to the application are executable, execute, on the first secure OS, a first TA corresponding to the first secure OS among the plurality of TAs, based on an execution result of the first TA being execution failure, execute a second secure OS with a second priority among secure OSs other than the first secure OS among the plurality of secure OSs, execute, on the second secure OS, a second TA corresponding to the second secure OS among the plurality of TAs, based on an execution result of the second TA being execution success, execute the application, wherein a TA includes an application being executed in a trusted execution environment (TEE), and wherein the plurality of secure OSs is executed in the TEE.

In accordance with another aspect of the disclosure, a storage medium storing at least one computer-readable instruction is provided.

In accordance with another aspect of the disclosure, one or more non-transitory computer-readable storage media storing one or more computer programs including computer-readable instruction that, when executed by one or more processors individually or collectively, cause the electronic device to perform operations are provided. The operations include identifying an execution request for an application in a rich execution environment (REE), based on the execution request for the application, executing a first secure operating system (OS) with a first priority among a plurality of secure OSs, based on configuration information for the application including priorities of the plurality of secure OSs in which a plurality of trusted applications (TAs) related to the application are executable, executing, on the first secure OS, a first TA corresponding to the first secure OS among the plurality of TAs, based on an execution result of the first TA being execution failure, executing a second secure OS with a second priority among secure OSs other than the first secure OS among the plurality of secure OSs, executing, on the second secure OS, a second TA corresponding to the second secure OS among the plurality of TAs, based on an execution result of the second TA being execution success, executing the application, wherein a TA may include an application being executed in a trusted execution environment (TEE), and wherein the plurality of secure OSs may be executed in the TEE.

In accordance with another aspect of the disclosure, a method of an electronic device is provided. The method includes identifying an execution request for an application in a rich execution environment (REE), based on the execution request for the application, executing a first secure operating system (OS) with a first priority among a plurality of secure OSs, based on configuration information for the application including priorities of the plurality of secure OSs in which a plurality of trusted applications (TAs) related to the application are executable, executing, on the first secure OS, a first TA corresponding to the first secure OS among the plurality of TAs, based on an execution result of the first TA being execution failure, executing a second secure OS with a second priority among secure OSs other than the first secure OS among the plurality of secure OSs, executing, on the second secure OS, a second TA corresponding to the second secure OS among the plurality of TAs, based on an execution result of the second TA being execution success, executing the application, wherein a TA may include an application being executed in a trusted execution environment (TEE), and wherein the plurality of secure OSs may be executed in the TEE.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying an execution request for an application in a rich execution environment (REE), based on the execution request for the application, executing a first secure operating system (OS) with a first priority among a plurality of secure OSs, based on configuration information for the application including priorities of the plurality of secure OSs in which a plurality of trusted applications (TAs) related to the application are executable, executing, on the first secure OS, a first TA corresponding to the first secure OS among the plurality of TAs, based on an execution result of the first TA being execution failure, executing a second secure OS with a second priority among secure OSs other than the first secure OS among the plurality of secure Oss, executing, on the second secure OS, a second TA corresponding to the second secure OS among the plurality of TAs, and based on an execution result of the second TA being execution success, executing the application, wherein a TA includes an application being executed in a trusted execution environment (TEE), and wherein the plurality of secure OSs are executed in the TEE.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating an electronic device within a network environment according to an embodiment of the disclosure;

FIG. 2 is a diagram for explaining a central processing unit (CPU) which provides a multi-execution environment according to an embodiment of the disclosure;

FIG. 3 is a diagram for explaining a software architecture according to a secure and a non-secure mode according to an embodiment of the disclosure;

FIG. 4 is a diagram for explaining a situation in which failure of an application occurs in an REE due to an abnormal operation of a TA in a TEE supporting a plurality of secure OSs according to an embodiment of the disclosure;

FIG. 5 is a diagram for explaining an operation of executing a TA in a TEE supporting a plurality of secure OSs according to an embodiment of the disclosure;

FIG. 6 is a diagram for explaining an operation of executing a TA in a TEE supporting a plurality of secure OSs according to an embodiment of the disclosure;

FIG. 7 is a diagram for explaining an operation of executing a TA in a TEE supporting a plurality of secure OSs according to an embodiment of the disclosure;

FIG. 8 is a flowchart illustrating an operating process of an electronic device according to an embodiment of the disclosure;

FIG. 9 is a diagram for explaining an operation of executing a TA in a TEE supporting a plurality of secure OSs according to an embodiment of the disclosure; and

FIG. 10 is a diagram illustrating a user interface of an electronic device which executes a TA in a TEE supporting a plurality of secure OSs according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, an embodiment of the disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an embodiment of the disclosure will describe an electronic device as an example, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an embodiment of the disclosure, the electronic device may be a device which has a communication function such as, for example, a mobile phone, a personal digital assistant (PDA), a smart phone, a wireless MODEM, and a notebook.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

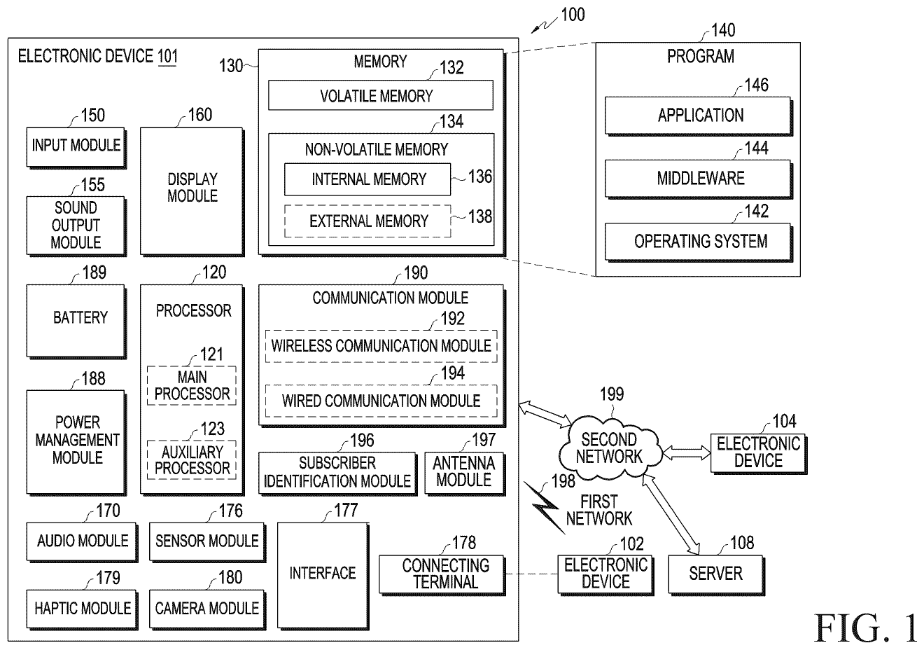

FIG. 1 is a block diagram schematically illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to one embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to one embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The processor 120 may include processing circuitry. The number of the processors 120 may be one or more. For example, the processor 120 may have a structure of a multi-core processor such as a dual core, a quad core, or a hexa core.

The processor 120 may control operations of the electronic device 101 by executing instructions stored in the memory 130. For example, the processor 120 may correspond to a plurality of processors which collectively perform a plurality of operations by dividing them among the processors.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. The receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) (a tablet and/or a smart watch) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

It should be noted that the communication module 190 may also be referred to as a “communication circuit”, and thus the communication module 190 and the communication circuit 190 may be used interchangeably as needed. The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

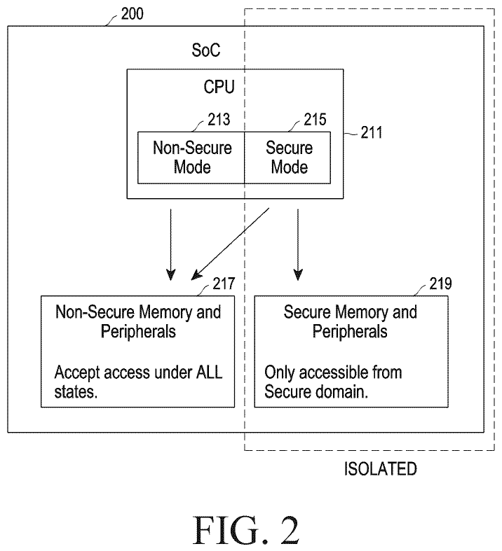

FIG. 2 is a diagram for explaining a central processing unit (CPU) which provides a multi-execution environment according to an embodiment of the disclosure.

Referring to FIG. 2, a secure zone technology is a technology for providing a multi-execution environment (e.g., a normal environment and a secure environment) and is used in a processor (e.g., a processor 120 in FIG. 1 or an application processor) to protect high-value code and data. The secure zone technology provides an efficient and system-wide approach to security using hardware-enforced isolation built in a central processing unit (CPU). The concepts of a secure zone (or a secure world or a trusted world) and a non-secure zone (or a non-secure world or a non-trusted world) in the secure zone technology are extended to encompass memory within a system on chip (SoC) (e.g., an application processor), software, bus transactions, interrupts, and peripheral devices.

This secure zone technology typically generates a trusted execution environment (TEE) by executing trusted booting and a trusted operating system (OS). The TEE is an independent application execution environment for performing an operation in which a relatively high-secure level which is greater than or equal to a threshold secure level is required within an electronic device. The TEE may be distinguished from a rich execution environment (REE), which is a typical application execution environment, in terms of hardware or software, and may load a secure operating system (OS) capable of executing a trusted application (TA). The TEE may be used for protecting an authentication mechanism, cryptography, mobile device management, payments, a key material, and digital rights management (DRM).

As illustrated in FIG. 2, if the secure zone technology is used, a CPU 211 in an SoC (e.g., the processor or the application processor) 200 may safely execute an application and process sensitive information based on a secure mode 215 separated from a non-secure mode 213 using hardware-enforced isolation. In FIG. 2, the non-secure mode 213 may correspond to an REE and a non-secure zone, and the secure mode 215 may correspond to a TEE and a secure zone.

Hardware 219 which may be used in the secure mode 215 may correspond to the TEE, and therefore may not be accessed by applications, kernels, and/or virtual machines (VMs) executed in the REE. Here, the hardware 219 which may be used in the secure mode 215 may include secure memory and secure peripherals and may be accessed only from a secure domain. The secure domain may correspond to the secure mode 215.

For example, hardware 217 which may be used in the non-secure mode 213 may correspond to the REE and thus may accept an access in all states. For example, the hardware 217 which may be used in the non-secure mode 213 may be accessed by applications, kernels, and/or VMs executed in the REE and the TEE.

An application executed in the REE may request execution of a trusted application (TA). The TA is an application executed in the TEE. After requesting the execution of the TA, the application executed in the REE may receive a response corresponding to the request. However, the application executed in the REE may not know information related to an encryption operation and a decryption operation for sensitive information, which has a secure level higher than or equal to a threshold secure level, performed in the TEE. Further, the application executed in the REE may not know information related to whether peripheral devices which may be executed in the TEE operate.

As described above, the secure zone technology may provide a more secure application execution environment by providing separate application execution environments such as the REE and the TEE.

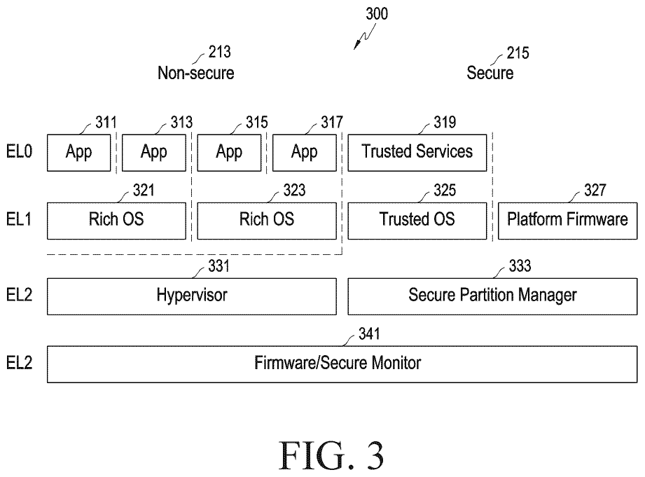

FIG. 3 is a diagram for explaining a software architecture according to a secure and a non-secure mode according to an embodiment of the disclosure.

Referring to FIG. 3, a software architecture 300 according to a secure mode and a non-secure mode may include a plurality of (for example, four) exception level (EL) zones. In an embodiment, the plurality of EL zones may include an EL0 zone, an EL1 zone, an EL2 zone, and an EL3 zone. In FIG. 3, the software architecture according to the secure mode and the non-secure mode is described using a software architecture of a Trustzone technology as an example, but the software architecture according to the secure mode and the non-secure mode may not be limited thereto.

In an embodiment, the EL0 zone may be a zone where an application and a platform are executed.

In an embodiment, the EL1 zone may be a zone where a kernel of an OS is executed.

In an embodiment, the EL2 zone may be a zone where a virtualization technology is supported.

In an embodiment, the EL3 zone may be a zone where a secure monitor call (SMC) is supported. In an embodiment, each EL zone except the EL3 zone may be divided corresponding to a non-secure mode 213 (e.g., a non-secure mode 213 in FIG. 2) and a secure mode 215 (e.g., a secure mode 215 in FIG. 2). In an embodiment, the non-secure mode 213 may correspond to an REE and a non-secure zone, and the secure mode 215 may correspond to a TEE and a secure zone. The non-secure zone may also be referred to as a normal zone (normal world).

In the non-secure mode 213, a plurality of applications 311, 313, 315, 317 may be executed in the EL0 zone. In an embodiment, in the non-secure mode 213, a plurality of OSs (Rich OSs) 321, 323 corresponding to a plurality of REE zones may be executed in the EL1 zone. In an embodiment, in the non-secure mode 213, a plurality of OSs 321, 323 may be executed, and a plurality of applications may be executed in each of the plurality of OSs 321, 323. For example, a case where the applications 311, 313 are executed in the OS 321, and the applications 315, 317 are executed in the OS 323 is illustrated in FIG. 3.

In an embodiment, a hypervisor 331 may be executed in the EL2 zone in the non-secure mode 213. In an embodiment, the hypervisor 331 may manage a VM and provide an isolated environment.

In an embodiment, trusted services (or TAs) 319 may be executed in the EL0 zone in the secure mode 215.

In an embodiment, in the secure mode 215, a trusted OS 325 and platform firmware 327 may be executed in the EL1 zone. In the secure mode 215, a plurality of secure OSs may be executed in the EL1 zone. For example, a case where the plurality of trusted services 319 are executed in the single trusted OS 325 is illustrated in FIG. 3. In the secure mode 215, a secure OS (or the trusted OS 325) and the platform firmware 327 may be executed to execute TAs. The platform firmware 327 may provide a function such as protected storage or Crypto at a relatively simple level compared to the secure OS, and may complete a necessary operation without executing a TA.

In an embodiment, in the secure mode 215, a secure partition manager (SPM) 333 may be executed in the EL2 zone. In the secure mode 215, a plurality of VMs, a plurality of secure services, and a plurality of secure drivers may be supported (or executed) at the same time in the EL2 zone.

In the non-secure mode 213 and the secure mode 215, a firmware/secure monitor 341 may be executed in the EL3 zone.

As a plurality of secure OSs may be supported in a TEE zone of a secure zone technology, a single processor (e.g., one application processor) may support a plurality of OSs. So, if a product (e.g., a processor and an SoC) equipped with a plurality of secure OSs is sold in a market, a user (or a TA developer) may identify a secure OS set by a chipset vendor or a finished product manufacturer in advance and reduce inconvenience of re-developing a TA which is executable on the identified secure OS. In addition, the user (or the TA developer) may select a more suitable application execution environment by identifying functions provided in the plurality of secure OSs or secure technologies applied to the plurality of secure OSs.

However, in order for the user to select a secure OS to execute a TA among the plurality of secure OSs, there may be the inconvenience of having to identify secure OSs supported in the electronic device in advance and select a specific secure OS among the secure OSs supported in the electronic device.

In addition, after execution of the TA is requested on the specific secure OS after the specific secure OS is selected, even if the plurality of secure OSs are supported in the TEE zone, an operation thereof may not different from an operation when only a single secure OS is supported. In particular, even if the TA is not executed normally on the selected secure OS, the TA may be executed normally in other secure OSs supported in the TEE. However, whenever the TA is not executed normally on the selected secure OS (e.g., whenever the TA operates abnormally on the selected secure OS), unless an exceptional processing which explicitly changes the secure OS is separately implemented, the abnormal operation of the TA may lead to failure of an operation in an REE associated with the TA. The abnormal operation of the TA may include failure of a normal operation of the TA and/or failure of an execution result of the TA.

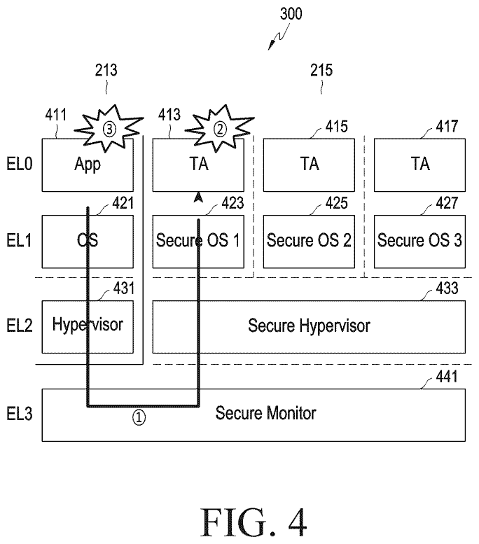

FIG. 4 is a diagram for explaining a situation in which failure of an application occurs in an REE due to an abnormal operation of a TA in a TEE supporting a plurality of secure OSs according to an embodiment of the disclosure.

Referring to FIG. 4, a software architecture 300 (e.g., a software architecture 300 in FIG. 3) according to a secure mode and a non-secure mode may include a plurality of (e.g., four) EL zones. In an embodiment, the plurality of EL zones may include an EL0 zone, an EL1 zone, an EL2 zone, and an EL3 zone. Each EL zone except the EL3 zone may be divided corresponding to a non-secure mode 213 (e.g., a non-secure mode 213 in FIG. 2 or 3) and a secure mode 215 (e.g., a secure mode 215 in FIG. 2 or 3). The non-secure mode 213 may correspond to an REE and a non-secure zone, and the secure mode 215 may correspond to a TEE and a secure zone. The non-secure zone may also be referred to as a normal zone (a normal world). In FIG. 4, the software architecture according to the secure mode and the non-secure mode is described using a software architecture of a Trustzone technology as an example, but the software architecture according to the secure mode and the non-secure mode may not be limited thereto.

In the non-secure mode 213, an application 411 may be executed in the EL0 zone.

In the non-secure mode 213, an OS 421 corresponding to an REE zone may be executed in the EL1 zone.

In the non-secure mode 213, a hypervisor 431 may be executed in the EL2 zone.

In the secure mode 215, a plurality of TAs 413, 415, 417 may be executed in the EL0 zone.

In the secure mode 215, a plurality of secure OSs, e.g., a first secure OS (secure OS 1) 423, a second secure OS (secure OS 2) 425, and a third secure OS (secure OS 3) 427, may be executed in the EL1 zone.

In the secure mode 215, a secure hypervisor 433 may be executed in the EL2 zone. In the secure mode 215, a plurality of VMs, a plurality of secure services, and a plurality of secure drivers may be supported (or executed) at the same time in the EL2 zone.

In the non-secure mode 213 and the secure mode 215, a secure monitor 441 may be executed in the EL3 zone.

First, as an execution request for the application 411 is identified in the non-secure mode 213, the OS 421 may call a function (or various functions such as a macro function) to be executed in the secure mode 215 using an application programming interface (API) provided in the secure mode 215. Based on the call of the OS 421, an SMC may be performed using an instruction for performing the SMC, and thus the first secure OS 423 may be executed.

As an execution request for the application 411 in the non-secure mode 213 is identified, the TA 413 associated with the application 411 may be executed in the first secure OS 423, which is a secure OS associated with the application 411 (\textcircled{1}). However, if an error occurs in the TA 413 (\textcircled{2}), the application 411 may also fail due to an abnormal operation of the TA 413 (\textcircled{3}). The abnormal operation of the TA may include failure of a normal operation of the TA and/or failure of an execution result of the TA.

In particular, if a serious error such as TEE_Panic occurs in TA 413 and the TA is abnormally terminated, it may be difficult for the application 411 to perform exceptional processing. If the serious error such TEE_Panic occurs, it may be difficult for the TEE to be used normally. TEE_Panic is an application programming interface (API) which causes a panic such as a kernel panic if a very serious problem occurs at a user platform terminal of the secure OS or the TA. The serious error such as TEE_Panic may occur in the following cases.

Case where an invalid request (e.g., a request without an access right to the trusted storage, or a request for an invalid operation) is transferred to trusted storage.

Case where an order of operations is invalid or a subject of an operation is invalid in a crypto operation, herein the crypto operation may include an encryption operation, a decryption operation, and/or a key generating operation.

Case where memory which needs to be accessed in relation to the crypto operation (for example, from which data needs to be read, and/or into which data needs to be written) does not exist, or even if the memory exists, capacity thereof is insufficient.

Case where interrupt handling fails.

Case where input/output (I/O) fails during a peripheral device communication (or a hardware communication).

Additionally, if an error occurs continuously in a TA associated with booting (e.g., Keymaster, File-based Encryption), the electronic device may enter an unusable state such as an infinite rebooting, before the OS 421 is loaded in the non-secure mode 215. The TA associated with the booting is generally a TA which detects an operation of specific hardware or in which an operation started by a function provided in the specific hardware needs to be completed necessarily.

If the TA associated with the booting is a TA which identifies whether a communication processor normally operates, if an error in the TA, a communication processor crash may occur. This communication processor crash may occur during booting or after booting.

If the TA associated with the booting is a TA which generates and manages a key using a key derivation function (KDF) provided in firmware, an error may occur in the TA, so a key may not be generated. As such, if the key is not generated, a subsequent operation (e.g., a binary check operation or a file check operation required for booting) may become impossible, so booting may become impossible.

Additionally, if an error occurs in a TA related to user authentication, a user may not release a lock state of the electronic device, and thus it may be impossible for the user to use the electronic device. For example, the user authentication may include personal identification number (PIN) authentication, pattern authentication, password authentication, fingerprint recognition, and/or face recognition.

If an error occurs in a TA which a user frequently uses and requires fast processing, such as a TA related to payment (e.g., Samsung PAY of Samsung™, or Samsung Wallet of Samsung™), an issue which is very sensitive to the user, such as failure of payment, may occur. A case where the error occurs in the TA related to the payment may be a case where a new TA may not be executed because a TA previously executed in a specific secure OS has not been terminated due to an unknown cause. In this case, there may be a high probability that the new TA will be executed normally if the new TA is executed on a secure OS different from the secure OS on which the TA which has been executed previously and has not been terminated normally.

Additionally, there may be an issue which occurs because a defect in hardware has a more serious impact on a particular secure OS than other secure OSs among a plurality of secure OSs. In the particular secure OS, just before the TA or the secure OS itself is executed in the electronic device, whether an encryption algorithms are successful may be tested. The encryption algorithms may include an encryption algorithm based on a true random number generator (TRNG) and/or a secure hash algorithm (SHA). As a result of the test, if the encryption algorithms fail, the TA or secure OS which has been intended to be executed may not be executed. If the encryption algorithms fail before the TA is executed, it may be impossible to execute only the TA and an application in the non-secure mode associated with the TA. However, on the contrary, if the encryption algorithms fail before the secure OS is executed, it may be impossible to boot the electronic device. Failure of a TA or a secure OS in the secure mode 215 due to the failure of the test for the encryption algorithms may be due to a hardware defect problem in which an invalid result is returned in a cryptography function of the hardware. If only an encryption operation implemented in software is used, a failure probability of a TA per secure OS or a failure probability of a secure OS may differ even for the same electronic device. For example, even for the same electronic device, it may be impossible for the TA or the secure OS itself to be executed in any one of the plurality of secure OSs due to the failure of the encryption algorithms, but because the encryption algorithms do not fail in other secure OS, it may be possible for the TA or the other secure OS to be executed. Therefore, the disclosure may provide an electronic device for executing a TA in a TEE supporting a plurality of secure OSs, and a method and storage medium thereof.

The disclosure may provide an electronic device for executing a TA by assigning priorities to a plurality of OSs related to the TA in a TEE supporting the plurality of secure OSs, and a method and storage medium thereof.

According to an embodiment of the disclosure, an electronic device 101 may comprise one or more processors 120 comprising processing circuitry, and memory 130 storing instructions.

According to another embodiment of the disclosure, the instructions that, when executed by the one or more processors individually or collectively, cause the electronic device to identify an execution request for an application in a rich execution environment (REE).

According to an embodiment of the disclosure, the instructions that, when executed by the one or more processors individually or collectively, cause the electronic device to, based on the execution request for the application, execute a first secure operating system (OS) with a first priority among a plurality of secure OSs, based on configuration information for the application including priorities of the plurality of secure OSs in which a plurality of trusted applications (TAs) related to the application are executable.

According to an embodiment of the disclosure, the instructions that, when executed by the one or more processors individually or collectively, cause the electronic device to execute, on the first secure OS, a first TA corresponding to the first secure OS among the plurality of TAs.

According to another embodiment of the disclosure, the instructions that, when executed by the one or more processors individually or collectively, cause the electronic device to, based on an execution result of the first TA being execution failure, execute a second secure OS with a second priority among secure OSs other than the first secure OS among the plurality of secure OSs.

According to an embodiment of the disclosure, the instructions that, when executed by the one or more processors individually or collectively, cause the electronic device to execute, on the second secure OS, a second TA corresponding to the second secure OS among the plurality of TAs.

According to an embodiment of the disclosure, the instructions that, when executed by the one or more processors individually or collectively, cause the electronic device to, based on an execution result of the second TA being execution success, execute the application.

According to an embodiment of the disclosure, a TA may include an application being executed in a trusted execution environment (TEE).

According to an embodiment of the disclosure, the plurality of secure OSs may be executed in the TEE.

The configuration information for the application may include locations where the plurality of TAs are stored on the plurality of secure OSs, locations where client applications (CAs) which communicate with the plurality of TAs in the REE are stored, names of the plurality of secure OSs, and versions of the plurality of secure OSs.

According to an embodiment of the disclosure, the configuration information for the application may include input parameters for the plurality of TAs, and expected output values for the plurality of TAs. In an embodiment, the configuration information for the application may include various parameters as necessary, and there may be no limitation thereto.

According to an embodiment of the disclosure, the instructions, when executed by the one or more processors individually or collectively, may cause the electronic device to, based on an execution result of the second TA being execution failure, execute a third secure OS with a third priority among secure OSs other than the first secure OS and the second secure OS among the plurality of secure OSs.

According to an embodiment of the disclosure, the instructions, when executed by the one or more processors individually or collectively, may cause the electronic device to execute, on the third secure OS, a third TA corresponding to the third secure OS among the plurality of TAs.

According to an embodiment of the disclosure, the instructions, when executed by the one or more processors individually or collectively, may cause the electronic device to, based on an execution result of the third TA being execution success, execute the application.

According to an embodiment of the disclosure, the instructions, when executed by the one or more processors individually or collectively, may cause the electronic device to, as at least part of, based on the execution result of the first TA being the execution failure, executing the second secure OS, based on the execution result of the first TA being the execution failure, identify a secure OS with a priority immediately following the first priority among the plurality of secure OSs, identify whether the identified secure OS is installed in the electronic device, and based on the identified secure OS being installed in the electronic device, set the identified secure OS as the second secure OS.

The instructions, when executed by the one or more processors individually or collectively, may cause the electronic device to, as at least part of, based on the execution result of the first TA being the execution failure, executing the second secure OS, based on the identified secure OS being not installed in the electronic device, identify a secure OS with a highest priority among remaining secure OSs other than the first secure OS and the identified secure OS among the plurality of secure OSs, identify whether the secure OS with the highest priority among the remaining secure OSs is installed in the electronic device, and based on the secure OS with the highest priority among the remaining secure OSs being installed in the electronic device, set the secure OS with the highest priority among the remaining secure OSs as the second secure OS.

According to an embodiment of the disclosure, the instructions, when executed by the one or more processors individually or collectively, may cause the electronic device to, based on identifying that the application is not executed after executing a set number of secure OSs among the plurality of secure OSs based on the priorities of the plurality of secure OSs, refrain from executing the application.

According to an embodiment of the disclosure, the instructions, when executed by the one or more processors individually or collectively, may cause the electronic device to provide information indicating execution failure for the application.

According to an embodiment of the disclosure, the instructions, when executed by the one or more processors individually or collectively, may cause the electronic device to, based on identifying that the application is not executed after executing at least part of the plurality of secure OSs based on the priorities of the plurality of secure OSs, refrain from executing the application.

According to an embodiment of the disclosure, the instructions, when executed by the one or more processors individually or collectively, may cause the electronic device to provide information indicating execution failure for the application.

According to an embodiment of the disclosure, a storage medium storing at least one computer-readable instruction may be provided.

According to an embodiment of the disclosure, the at least one instruction, when executed by one or more processors (120) including processing circuitry of an electronic device (101) individually or collectively, may cause the electronic device to perform at least one operation.

The at least one operation may comprise identifying an execution request for an application in a rich execution environment (REE).

According to an embodiment of the disclosure, the at least one operation may comprise, based on the execution request for the application, executing a first secure operating system (OS) with a first priority among a plurality of secure OSs, based on configuration information for the application including priorities of the plurality of secure OSs in which a plurality of trusted applications (TAs) related to the application are executable.

According to an embodiment, the at least one operation may comprise executing, on the first secure OS, a first TA corresponding to the first secure OS among the plurality of TAs.

According to an embodiment of the disclosure, the at least one operation may comprise, based on an execution result of the first TA being execution failure, executing a second secure OS with a second priority among secure OSs other than the first secure OS among the plurality of secure OSs.

According to an embodiment of the disclosure, the at least one operation may comprise executing, on the second secure OS, a second TA corresponding to the second secure OS among the plurality of TAs.

According to an embodiment, the at least one operation may comprise, based on an execution result of the second TA being execution success, executing the application.

According to an embodiment of the disclosure, a TA may include an application being executed in a trusted execution environment (TEE).

According to an embodiment of the disclosure, the plurality of secure OSs may be executed in the TEE.

According to an embodiment of the disclosure, the configuration information for the application may include locations where the plurality of TAs are stored on the plurality of secure OSs, locations where client applications (CAs) which communicate with the plurality of TAs in the REE are stored, names of the plurality of secure OSs, and versions of the plurality of secure OSs.

According to an embodiment of the disclosure, the configuration information for the application may include input parameters for the plurality of TAS, and expected output values for the plurality of TAs. In an embodiment, the configuration information for the application may include various parameters as necessary, and there may be no limitation thereto.

The at least one operation may comprise, based on an execution result of the second TA being execution failure, executing a third secure OS with a third priority among secure OSs other than the first secure OS and the second secure OS among the plurality of secure OSs.

According to an embodiment of the disclosure, the at least one operation may comprise executing, on the third secure OS, a third TA corresponding to the third secure OS among the plurality of TAs.

According to an embodiment of the disclosure, the at least one operation may comprise, based on an execution result of the third TA being execution success, executing the application.

According to an embodiment of the disclosure, based on the execution result of the first TA being the execution failure, executing the second secure OS may comprise, based on the execution result of the first TA being the execution failure, identifying a secure OS with a priority immediately following the first priority among the plurality of secure OSs, identifying whether the identified secure OS is installed in the electronic device, and based on the identified secure OS being installed in the electronic device, setting the identified secure OS as the second secure OS.

According to an embodiment of the disclosure, based on the execution result of the first TA being the execution failure, executing the second secure OS may comprise, based on the identified secure OS being not installed in the electronic device, identifying a secure OS with a highest priority among remaining secure OSs other than the first secure OS and the identified secure OS among the plurality of secure OSs, identifying whether the secure OS with the highest priority among the remaining secure OSs is installed in the electronic device, and based on the secure OS with the highest priority among the remaining secure OSs being installed in the electronic device, setting the secure OS with the highest priority among the remaining secure OSs as the second secure OS.

According to an embodiment of the disclosure, the at least one operation may comprise, based on identifying that the application is not executed after executing a set number of secure OSs among the plurality of secure OSs based on the priorities of the plurality of secure OSs, refraining from executing the application.

The at least one operation may comprise providing information indicating execution failure for the application.

According to an embodiment of the disclosure, the at least one operation may comprise, based on identifying that the application is not executed after executing at least part of the plurality of secure OSs based on the priorities of the plurality of secure OSs, refraining from executing the application.

According to an embodiment of the disclosure, the at least one operation may comprise providing information indicating execution failure for the application.

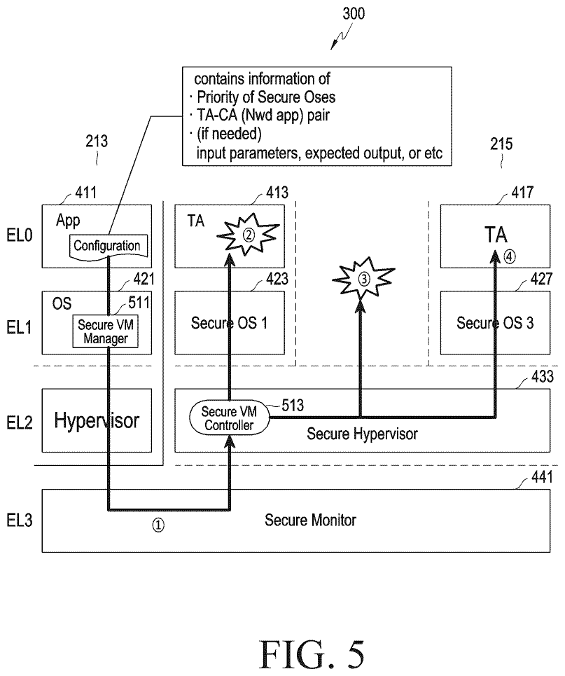

FIG. 5 is a diagram for explaining an operation of executing a TA in a TEE supporting a plurality of secure OSs according to an embodiment of the disclosure.

Referring to FIG. 5, a software architecture 300 (e.g., a software architecture 300 in FIG. 3 or 4) according to a secure mode and a non-secure mode may include a plurality of (e.g., four) EL zones. In an embodiment, the plurality of EL zones may include an EL0 zone, an EL1 zone, an EL2 zone, and an EL3 zone. Each EL zone except the EL3 zone may be divided corresponding to a non-secure mode 213 (e.g., a non-secure mode 213 in FIG. 2, 3, or 4) and a secure mode 215 (e.g., a secure mode 215 in FIG. 2, 3, or 4). The non-secure mode 213 may correspond to an REE and a non-secure zone, and the secure mode 215 may correspond to a TEE and a secure zone. The non-secure zone may also be referred to as a normal zone (a normal world). In the following description, the non-secure mode, the REE, the non-secure zone, and the normal zone may be used interchangeably, and may be used in substantially the same meaning. In addition, in the following description, the secure mode, the TEE, and the secure zone may be used interchangeably, and may be used in substantially the same meaning. In FIG. 5, the software architecture according to the secure mode and the non-secure mode is described using a software architecture of a Trustzone technology as an example, but the software architecture according to the secure mode and the non-secure mode may not be limited thereto.

In the non-secure mode 213, an application 411 (e.g., an application 411 in FIG. 4) may be executed in the EL0 zone. In FIG. 5, an operation according to an embodiment of the disclosure will be described using the application 411 included in the EL0 zone as an example, but the operation according to an embodiment of the disclosure may also be applied to an application included in the EL1 zone as well as the EL0 zone. In this case, the application included in the EL1 zone may include a kernel application.

In the non-secure mode 213, an OS 421 (e.g., an OS 421 in FIG. 4) corresponding to an REE zone may be executed in the EL1 zone.

In the non-secure mode 213, a hypervisor 431 (e.g., a hypervisor 431 in FIG. 4) may be executed in the EL2 zone.

In the secure mode 215, a plurality of TAs 413, 417 (e.g., TAs 413, 417 in FIG. 4) may be executed in the EL0 zone.

In the secure mode 215, a plurality of secure OSs, e.g., a first secure OS 423 (e.g., a first secure OS 423 in FIG. 4) and a third secure OS 427 (e.g., a third secure OS 427 in FIG. 4), may be executed in the EL1 zone. In this case, an application included in the EL1 zone may include a secure kernel application.

In the secure mode 215, a secure hypervisor 433 (e.g., a secure hypervisor 433 in FIG. 4) may be executed in the EL2 zone. In the secure mode 215, a plurality of VMs, a plurality of secure services, and a plurality of secure drivers may be supported (or executed) at the same time in the EL2 zone.

In the non-secure mode 213 and the secure mode 215, a secure monitor 441 (e.g., a secure monitor 441 in FIG. 4) may be executed in the EL3 zone.

First, as an execution request for the application 411 is identified in the non-secure mode 213, the application 411 may transfer a TA execution request for requesting execution of a TA associated with the application 411 to a secure VM manager 511. In an embodiment, the TA execution request may include configuration information (or a configuration file) including information about a plurality of secure OSs on which a plurality of TAs associated with the application 411 are executable.

In an embodiment, upon receiving the TA execution request from the application 411, the secure VM manager 511 may request the secure VM controller 513 to execute a corresponding S-VM using an SMC based on the received TA execution request. In an embodiment, the secure VM manager 511 may be included in the EL1 zone of the non-secure mode 213.

In an embodiment, the secure VM controller 513 may load a VM of the secure mode 215 or execute a VM requested by the secure VM manager 511. In an embodiment, the secure VM controller 513 may be included in the EL2 zone of the secure mode 215.

Configuration information for the application 411 may include information related to a plurality of secure OSs on which a plurality of TAs related to the application 411 are executable. In an embodiment, the information related to the plurality of secure OSs may include priorities for the plurality of secure OSs, pieces of unique information for the plurality of secure OSs, locations where the plurality of TAs are stored on the plurality of secure OSs, locations where client applications (CAs) in the REE (or the non-secure mode 213) which communicates with the plurality of TAs are stored, and/or additional information. In an embodiment, the additional information may include various parameters as needed, and there may be no limitation thereto.

In an embodiment, unique information about a secure OS may include a name of the secure OS and/or a version of the secure OS.

In an embodiment, the additional information may include input parameters for the TA and/or expected output values for the TA. An input parameter for the TA may include a parameter inputted when the TA is executed. An expected output value for the TA may include an output value expected when the TA is executed. In an embodiment, the expected output value for the TA may include an error code.

In an embodiment, the additional information may optionally be added to the configuration information for the application 411, and thus, the additional information may or may not be added to the configuration information for the application 411 as needed.

In an embodiment, the configuration information for the application 411 may be generated when the application 411 is developed, but may not be limited thereto.

In an embodiment, the configuration information for the application 411 needs to be written in a format which may be parsed in the secure VM manager 511. If the secure VM manager 511 is capable of supporting a plurality of file formats, the configuration information for the application 411 may be generated using the plurality of file formats. For example, if the secure VM manager 511 is capable of supporting an extensible markup language (XML), a YML, and javascript object notation (JSON), the configuration information for the application 411 may be generated using any one file format of the XML, the YML, and the JSON.

Table 1 below may show the configuration information for the application 411 written using the XML.

TABLE 1

| | |
|---|---|
| XML | <TEE_LIST> |
| | <TEE priority= [symbol] > |
| | <OS>TEEgris</OS> |
| | <version>6.0</version> |
| | <CA>/vendor/bin/tee_client_application</CA> |
| | <TA>/vendor/tee/00000000-0000-0000-0000-1234567890ab</TA> |
| | <option input_param= [symbol] 1000. 0 [symbol] ></option> |
| | <option expected_result= [symbol] Success \|\| Short_Buffer [symbol] ></option> |
| | </TEE> |
| | <TEE priority= [symbol] 2 [symbol] > |
| | <OS> [symbol] SEE</OS> |
| | <version>5.0 [symbol] /version> |
| | <CA>/vendor/bin/client_application</CA> |
| | <TA>/ [symbol] _images/secure [symbol] zone/ [symbol] / [symbol] </TA> |
| | </TEE> |
| | </TEE_LIST> |

[symbol]

indicates data missing or illegible when filed

In Table 1, TEE_LIST may represent the configuration information for the application 411. In Table 1, TEE priority may represent a priority for the secure OS.

As shown in Table 1, the configuration information for the application 411 may include information related to two secure OSs (e.g., information related to TEEgris which is a secure OS whose value of a priority is set to “1,” and information related to QSEE which is a secure OS whose value of a priority is set to “2”).

As shown in Table 1, the information related to TEEgris may include the priority of TEEgris (e.g., TEE priority=“1”), a version of TEEgris (e.g., version 6.0), a location where a CA corresponding to TEEgris is stored (e.g., /vendor/bin/tee_client_application), a location where a TA corresponding to TEEgris is stored (e.g., /vendor/tee/00000000-0000-0000-0000-1234567890ab), a TA input parameter (e.g., input_param=“1000, 0”), and an expected output value (e.g., expected_result=“Success∥Short_Buffer”).

As shown in Table 1, the information related to QSEE may include the priority of QSEE (e.g., TEE priority=“2”), a version of QSEE (e.g., version 5.0), a location where a CA corresponding to QSEE is stored (e.g., /vendor/bin/client_application), and a location where a TA corresponding to QSEE is stored (e.g., /nhlos/trustzone_images/securemsm/trustzone/qsapps/ta.mbn).

Table 2 below may show the configuration information for the application 411 written using the JSON.

TABLE 2

| | |
|---|---|
| JSON | { |
| | [symbol] TEE_LIST [symbol] : { |
| | [symbol] TEE [symbol] : \| |
| | { |
| | [symbol] priority [symbol] : [symbol] 1 [symbol] , |
| | [symbol] OS [symbol] : [symbol] TEEgris [symbol] , |
| | [symbol] version [symbol] : [symbol] 6.0 [symbol] , |
| | [symbol] CA [symbol] : [symbol] /vendor/bin/tee_client_application [symbol] . |
| | [symbol] TA [symbol] : [symbol] /vendor/tee/00000000-0000-0000-0000-1234567890ab [symbol] , |
| | [symbol] option [symbol] : [ |
| | { [symbol] input_param [symbol] : [symbol] 1000, 0 [symbol] } [symbol] |
| | { [symbol] expected_result [symbol] : [symbol] Success \|\| Short_Buffer [symbol] } |
| | ] |
| | }, |
| | { |
| | [symbol] priority [symbol] : [symbol] 2 [symbol] , |
| | [symbol] OS [symbol] : [symbol] SEE [symbol] , |
| | [symbol] version [symbol] : [symbol] 5.0 [symbol] , |
| | [symbol] CA [symbol] : [symbol] /vendor/bin/client_application [symbol] , |
| | [symbol] TA [symbol] : [symbol] / [symbol] zone_images/secure [symbol] .mbn [symbol] |
| | } |
| | ] |
| | } |
| | } |

[symbol]

indicates data missing or illegible when filed

In Table 2, TEE_LIST may represent the configuration information for the application 411. In Table 2, priority may represent a priority for the secure OS.

As shown in Table 2, the configuration information for the application 411 may include information related to two secure OSs (e.g., information related to TEEgris which is a secure OS whose value of a priority is set to “1,” and information related to QSEE which is a secure OS whose value of a priority is set to “2”).

As shown in Table 2, the information related to TEEgris may include the priority of TEEgris (e.g., “priority”: “1”), a version of TEEgris (e.g., version 6.0), a location where a CA corresponding to TEEgris is stored (e.g., /vendor/bin/tee_client_application), a location where a TA corresponding to TEEgris is stored (e.g., /vendor/tee/00000000-0000-0000-0000-1234567890ab), a TA input parameter (e.g., input_param=“1000, 0”), and an expected output value (e.g., expected_result=“Success∥Short_Buffer”).

As shown in Table 2, the information related to QSEE may include the priority of QSEE (e.g., “priority”: “2”), a version of QSEE (e.g., version 5.0), a location where a CA corresponding to QSEE is stored (e.g., /vendor/bin/client_application), and a location where a TA corresponding to QSEE is stored (e.g., /nhlos/trustzone_images/securemsm/trustzone/qsapps/ta.mbn).

As described above, as the execution request for the application 411 is identified in the non-secure mode 213, the application 411 may transfer the TA execution request for requesting the execution of the TA related to the application 411 to the secure VM manager 511.

The secure VM manager 511, which receives the TA execution request for requesting the execution of the TA related to the application 411 from the application 411, may parse the configuration information (or the configuration file) for the application 411 included in the received TA execution request to transfer a secure VM (S-VM) execution request for requesting the secure VM controller 513 to execute the S-VM corresponding to the priorities of the secure OSs (\textcircled{1}). In an embodiment, the S-VM may correspond to the secure OS. Since the configuration information for the application 411 includes the information related to the plurality of secure OSs, the secure VM manager 511 may transfer the S-VM execution request to the secure VM controller 513 starting from a secure OS with the highest priority among the plurality of secure OSs based on a priority. In FIG. 5, it will be assumed that a priority of the first secure OS 423 is the highest, a priority of the second secure OS is the next highest, and finally, a priority of the third secure OS 427 is the lowest. Accordingly, the secure VM manager 511 may transfer an S-VM execution request for requesting the secure VM controller 513 to execute an S-VM corresponding to the first secure OS 423.

The secure VM controller 513, which receives the S-VM execution request from the secure VM manager 511, may execute the corresponding S-VM (or the first secure OS 423) based on the received S-VM execution request, and cause the TA 413 related to the application 411 to be executed in the corresponding S-VM (or the first secure OS 423) (\textcircled{2}).

In an embodiment, an execution result of the TA 413 may be transferred to the secure VM manager 511, and the secure VM manager 511 may identify whether to execute an S-VM corresponding to a secure OS of the next priority related to the application 411 based on the execution result of the TA 413. In an embodiment, if the execution result of the TA 413 indicates execution failure, the secure VM manager 511 may determine to execute the S-VM corresponding to the secure OS of the next priority related to the application 411. In an embodiment, the execution failure of the TA 413 may occur if it is impossible to execute the TA 413, or if the first secure OS 423, which is a secure OS on which the TA 413 is executed, is abnormally terminated (for example, if the first secure OS 423 is abnormally terminated due to a serious error such as TEE_Panic). TEE_Panic has been described in FIG. 4, so a repeated description may be omitted herein.

In FIG. 5, since it has been assumed that the priority of the second secure OS is high after the priority of the first secure OS 423, if the execution result of the TA 413 indicates the execution failure, the secure VM manager 511 may determine to execute an S-VM corresponding to the second secure OS with the next priority related to the application 411.

Since the TA 413 has failed to be executed in the first secure OS 423, the secure VM manager 511 may transfer, to the secure VM controller 513 based on a priority, an S-VM execution request for requesting to execute an S-VM corresponding to the second secure OS, which is a secure OS with the highest priority among security OSs other than the first secure OS 423 among the plurality of secure OSs.

The secure VM controller 513, which receives the S-VM execution request from the secure VM manager 511, needs to execute the corresponding S-VM (or the second secure OS) based on the received S-VM execution request and cause a TA related to the application 411 to be executed in the corresponding S-VM (or the second secure OS). However, if the S-VM (or the second secure OS) corresponding to the S-VM execution request received from the secure VM manager 511 is not installed in an electronic device (e.g., an electronic device 101 in FIG. 1), the secure VM controller 513 may transfer information indicating that the corresponding S-VM (or the second secure OS) does not exist to the secure VM manager 511 (\textcircled{3}).

In FIG. 5, the secure VM controller 513 manages a list of secure OSs (or S-VMs) installed in the electronic device, and therefore, the secure VM manager 511 may need to inquire whether the second secure OS is installed in the electronic device to the secure VM controller 513 in order to identify whether the second secure OS is installed in the electronic device. So, before separately inquiring whether the second secure OS is installed in the electronic device to the secure VM controller 513, the secure VM manager 511 may not identify whether the second secure OS is installed in the electronic device. So, the secure VM manager 511 may transfer the S-VM execution request corresponding to the second secure OS to the secure VM controller 513, and the secure VM controller 513, which receives the S-VM execution request, may identify whether the second secure OS is installed in the electronic device.

Alternatively, the secure VM manager 511 may store the list of the secure OSs installed in the electronic device. In this case, the secure VM manager 511 may transfer the S-VM execution request to the secure VM controller 513 only for the secure OSs installed in the electronic device among the secure OSs corresponding to the configuration information for the application 411. In FIG. 5, since only the first secure OS 423 and the third secure OS 427 are installed in the electronic device, the list of the secure OSs may include only the first secure OS 423 and the third secure OS 427. So, since the TA 412 failed to be executed in the first secure OS 423, the secure VM manager 511 may identify, based on the list of the secure OSs, whether the second secure OS, which is the secure OS with the highest priority among the secure OSs other than the first secure OS 423 among the plurality of secure OSs, is installed in the electronic device. In FIG. 5, since the second secure OS is not installed on the electronic device, the secure VM manager 511 may identify whether the third secure OS 427, which is a secure OS with the highest priority among secure OSs other than the first secure OS 423 and the second secure OS among the plurality of secure OSs, is installed in the electronic device.

In an embodiment, the list of the secure OSs installed in the electronic device may vary according to criteria for generating a list of secure OSs.

If the list of secure OSs is generated based on whether an S-VM execution file is stored, the list of secure OSs may be stored in the secure VM manager 511. This may be because the S-VM execution file is typically stored in the non-secure mode 213.

In an embodiment, if the list of secure OSs is generated based on whether loading of the S-VM is successful, the list of secure OSs may be stored in the secure VM controller 513. This may be to generate the list of secure OSs by considering only S-VMs which have actually been normally loaded in the secure mode 215.

Since the TA failed to be executed in the second secure OS, the secure VM manager 511 may transfer, to the secure VM controller 513 based on a priority, an S-VM execution request for requesting to execute an S-VM corresponding to the third secure OS 427 which is the secure OS with the highest priority among the secure OSs other than the first secure OS 423 and the second secure OS among the plurality of secure OSs.

The secure VM controller 513, which receives the S-VM execution request from the secure VM manager 511, may execute the corresponding S-VM (or the third secure OS 427) based on the received S-VM execution request and cause the TA 417 related to the application 411 to be executed in the corresponding S-VM (or the third secure OS 427) (\textcircled{4}).

In an embodiment, an execution result of the TA 417 may be transferred to the secure VM manager 511, and the secure VM manager 511 may identify whether to execute an S-VM corresponding to a secure OS of the next priority related to the application 411 based on the execution result of the TA 417.

In an embodiment, if the execution result of the TA 417 indicates execution success, the secure VM manager 511 may transfer the execution result of the TA 417 to the application 411. The application 411, which receives the execution result of the TA 417 from the secure VM manager 511, may be terminated after being executed normally.

If the execution result of TA 417 indicates execution failure, the secure VM manager 511 may transfer information indicating the execution failure of the application 411 to the application 411 because there are no more secure OSs on which the TAs related to the application 411 are executable in the electronic device (for example, because there are no more secure OSs corresponding to the configuration information for the application 411 in the electronic device).

In FIG. 5, a case where the secure VM manager 511 executes the application 411 by considering all of the plurality of secure OSs included in the configuration information for the application 411 has been described as an example, but the application 411 may be also executed by considering only a set number of secure OSs among the plurality of secure OSs included in the configuration information for the application 411. Alternatively, the secure VM manager 511 may also execute the application 411 by considering at least some of the plurality of secure OSs included in the configuration information for the application 411 during set time. As such, the reason for considering the set number of secure OSs or the secure OSs during the set time without considering all of the plurality of secure OSs included in the configuration information for the application 411 may be to prevent service quality deterioration due to execution delay of the application 411.

In FIG. 5, a case where the secure VM manager 511 is included in the non-secure mode 213 and the secure VM controller 513 is included in the secure mode 215 has been described as an example, but there may be no limitation on a mode in which the secure VM manager 511 and the secure VM controller 513 are included. For example, the secure VM manager 511 may be included in the secure mode 215 and the secure VM controller 513 may be included in the non-secure mode 213. For example, some of operations performed by the secure VM manager 511 may be implemented to be included in the non-secure mode 213, and the rest of the operations performed by the secure VM manager 511 may be implemented to be included in the secure mode 215. For example, some of operations performed by the secure VM controller 513 may be implemented to be included in the secure mode 215, and the rest of the operations performed by the secure VM controller 513 may be implemented to be included in the non-secure mode 213.

As described above, a secure VM manager and a secure VM controller may perform a connected operation through a communication with each other, and thus the secure VM manager and the secure VM controller may be integrated into one module. In the following description, the one module in which the secure VM manager and the secure VM controller are integrated will be referred to as a “secure VM manager” for convenience of a description.

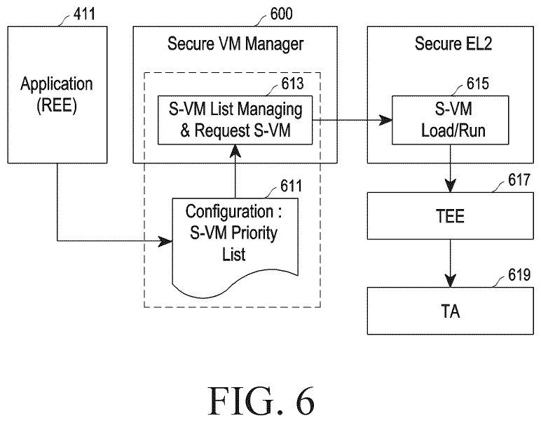

FIG. 6 is a diagram for explaining an operation of executing a TA in a TEE supporting a plurality of secure OSs according to an embodiment of the disclosure.

Referring to FIG. 6, an operation of executing a TA in a TEE supporting a plurality of secure OSs described in FIG. 6 may differ in that a secure VM manager (e.g., a secure VM manager 511 in FIG. 5) and a secure VM controller (e.g., a secure VM controller 513 in FIG. 5) are implemented in a form of an integrated secure VM manager 600 compared to an operation of executing a TA in a TEE supporting a plurality of secure OSs described in FIG. 5.

As described in FIG. 5, as an execution request for an application 411 (e.g., an application 411 in FIG. 4 or 5) is identified in an REE (or a non-secure mode, a non-secure zone, or a normal zone), the application 411 may transfer a TA execution request for requesting execution of a TA related to the application 411 to the secure VM manager 600 (operation 611). The secure VM manager 600 in FIG. 6 may be a module in which the secure VM manager and the secure VM controller described in FIG. 5 are integrated. In an embodiment, the TA execution request may include configuration information (or a configuration file) including information about a plurality of secure OSs on which a plurality of TAs related to the application 411 are executable. In an embodiment, the configuration information for the application 411 may include information related to the plurality of secure OSs on which the plurality of TAs related to the application 411 are executable. In an embodiment, the information related to the plurality of secure OSs may include priorities for the plurality of secure OSs, pieces of unique information for the plurality of secure OSs, locations where the plurality of TAs are stored in the plurality of secure OSs, locations where CAs which communicate with the plurality of TAs in the REE are stored, and/or additional information. The configuration information for the application 411 has been described in FIG. 5, so a repeated description thereof may be omitted herein. As described in FIG. 5, the configuration information for the application 411 may be implemented in a form of a list based on priorities of secure OSs (or S-VMs), and therefore, it may need to be noted that in FIG. 6, the configuration information for the application 411 is expressed as an “S-VM priority list.”

In an embodiment, upon receiving the TA execution request from the application 411, the secure VM manager 600 may request to execute a corresponding S-VM using an SMC based on the received TA execution request (operation 613). In an embodiment, the secure VM manager 600, which receives the TA execution request for requesting to execute the TA related to the application 411 from the application 411, may parse the configuration information (or the configuration file) for the application 411 included in the received TA execution request to execute a corresponding S-VM (or secure OS) corresponding to the priorities for the secure OSs (operation 615). In an embodiment, an operation of executing the S-VM may include an operation (S-VM Load/Run) of loading the S-VM and executing the loaded S-VM. In an embodiment, the S-VM may correspond to a secure OS. Since the configuration information for the application 411 includes the information related to the plurality of secure OSs, the secure VM manager 600 may request to execute the S-VM starting from a secure OS with the highest priority among the plurality of secure OSs based on a priority. An operation related to execution of secure OSs and corresponding TAs based on the priority may be implemented to be similar to or substantially the same as that described in FIG. 5, so a repeated description thereof may be omitted herein.

The secure VM manager 600, which executes the corresponding S-VM (or secure OS) may cause a TA 619 related to the application 411 to be executed in the corresponding S-VM (or secure OS) in a TEE 617 (or a secure mode or a secure zone).

In another embodiment, an execution result of the TA 619 may be transferred to the secure VM manager 600, and the secure VM manager 600 may identify whether to execute an S-VM corresponding to a secure OS of the next priority related to the application 411 based on the execution result of the TA 619. In an embodiment, if the execution result of the TA 619 indicates execution failure, the secure VM manager 600 may determine to execute the S-VM corresponding to the secure OS of the next priority related to the application 411. In an embodiment, the execution failure of the TA 619 may occur if it is impossible to execute the TA 619, or if a secure OS on which the TA 619 is executed, is abnormally terminated (for example, if the secure OS is abnormally terminated due to a serious error such as TEE_Panic). TEE_Panic has been described in FIG. 4, so a repeated description may be omitted herein. An operation of the secure VM manager 600 executing the secure OS of the next priority and the corresponding TA may be implemented to be similar to or substantially the same as that described in FIG. 5, so a repeated description thereof may be omitted herein.

In an embodiment, if the execution result of the TA 619 indicates execution success, the secure VM manager 600 may transfer the execution result of the TA 619 to the application 411. The application 411 which receives the execution result of the TA 619 from the secure VM manager 600 may be terminated after being executed normally.

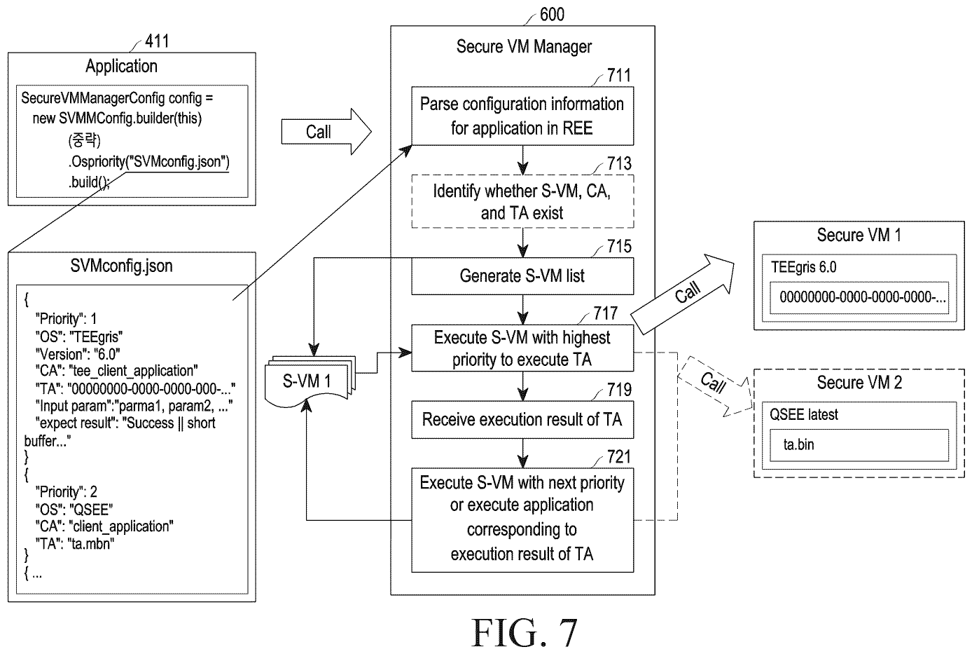

FIG. 7 is a diagram for explaining an operation of executing a TA in a TEE supporting a plurality of secure OSs according to an embodiment of the disclosure.

Referring to FIG. 7, an operation of executing a TA in a TEE supporting a plurality of secure OSs described in FIG. 7 may differ in that a secure VM manager (e.g., a secure VM manager 511 in FIG. 5) and a secure VM controller (e.g., a secure VM controller 513 in FIG. 5) are implemented in a form of an integrated secure VM manager 600 (e.g., a secure VM manager 600 in FIG. 6) compared to an operation of executing a TA in a TEE supporting a plurality of secure OSs described in FIG. 5.

As described in FIG. 5, as an execution request for an application 411 (e.g., an application 411 in FIG. 4, 5, or 6) is identified in an REE (or a non-secure mode, a non-secure zone, or a normal zone), the application 411 may transfer a TA execution request for requesting execution of a TA related to the application 411 to the secure VM manager 600. The secure VM manager 600 in FIG. 7 may be a module in which the secure VM manager and the secure VM controller described in FIG. 5 are integrated. In an embodiment, the TA execution request may include configuration information (or a configuration file) including information about a plurality of secure OSs on which a plurality of TAs related to the application 411 are executable. In FIG. 7, the configuration information for the application 411 is represented as SVMconfig.json. As described in FIG. 5, the configuration information for the application 411 may be generated using, for example, any one file format of an XML, a YML, and JSON, and the configuration information (SVMconfig.json) for the application 411 written using the JSON as described in Table 2 is illustrated in FIG. 7.

In an embodiment, the configuration information for the application 411 may include information related to the plurality of secure OSs on which the plurality of TAs related to the application 411 are executable. In an embodiment, the information related to the plurality of secure OSs may include priorities for the plurality of secure OSs, pieces of unique information for the plurality of secure OSs, locations where the plurality of TAs are stored in the plurality of secure OSs, locations where CAs which communicate with the plurality of TAs in the REE are stored, and/or additional information. The configuration information for the application 411 has been described in FIG. 5, so a repeated description thereof may be omitted herein.

In an embodiment, the secure VM manager 600 may largely need to perform the following two operations.

The first operation may be an operation of parsing the configuration information (e.g., SVMconfig.json) for the application 411 to transfer the parsed information to a related S-VM when the related S-VM is executed. As described in FIG. 5, the configuration information for the application 411 may be implemented in a form of a list based on priorities of secure OSs (or S-VMs), and therefore, the configuration information for the application 411 may be expressed as an “S-VM priority list.” The secure VM manager 600 may identify a secure OS which is not installed in an electronic device (e.g., an electronic device 101 in FIG. 1) among the secure OSs included in the S-VM priority list, and may generate an S-VM list including the remaining secure OSs excluding the secure OS which is not installed in the electronic device among the secure OSs included in the S-VM priority list.

The second operation may be an operation of executing the application 411 in consideration of the secure OSs based on a priority, corresponding to the S-VM list. The operation of executing the application 411 in consideration of the secure OSs based on the priority may be implemented to be similar to or substantially the same as that described in FIG. 5, so a repeated description thereof may be omitted herein.

An operation of the secure VM manager 600 may be described as follows.

The secure VM manager 600 which receives the TA execution request from the application 411 may, in operation 711, parse the configuration information (or the configuration file) for the application 411 included in the received TA execution request.

The secure VM manager 600 which parses the configuration information (or the configuration file) for the application 411 may, in operation 713, identify whether the secure OSs included in the S-VM priority list are installed in the electronic device. In an embodiment, the secure VM manager 600 may, in operation 713, identify whether CAs and TAs included in the S-VM priority list are installed in the electronic device.

In operation 715, the secure VM manager 600 may generate an S-VM list based on whether the secure OSs included in the S-VM priority list are installed in the electronic device and whether the CAs and the TAs included in the S-VM priority list are installed in the electronic device. The secure VM manager 600 may generate the S-VM list by removing, from the S-VM priority list, secure OSs, CAs, and TAs not installed in the electronic device among the secure OSs, the CAs, and the TAs included in the S-VM priority list.

The secure VM manager 600 which generates the S-VM list may, in operation 717, execute an S-VM (or a secure OS) with the highest priority among secure OSs included in the S-VM list, and execute a corresponding TA in the corresponding secure OS. Since the S-VM list includes information related to a plurality of secure OSs, the secure VM manager 600 may request to execute an S-VM starting from the secure OS with the highest priority among the plurality of secure OSs based on a priority. An operation related to execution of secure OSs and corresponding TAs based on the priority may be implemented to be similar to or substantially the same as that described in FIG. 5, so a repeated description thereof may be omitted herein.

The secure VM manager 600 which executes the corresponding S-VM (or secure OS) may receive an execution result of the TA in operation 719. The secure VM manager 600 which receives the execution result of the TA may, in operation 721, execute an S-VM corresponding to a secure OS of the next priority related to the application 411 or execute the application 411 based on the execution result of the TA. In an embodiment, if the execution result of the TA indicates execution failure, the secure VM manager 600 may determine to execute the S-VM corresponding to the secure OS of the next priority related to the application 411. In an embodiment, the execution failure of the TA may occur if it is impossible to execute the TA, or if a secure OS on which the TA is executed, is abnormally terminated (for example, if the secure OS is abnormally terminated due to a serious error such as TEE_Panic). TEE_Panic has been described in FIG. 4, so a repeated description may be omitted herein. An operation of the secure VM manager 600 executing the secure OS of the next priority and the corresponding TA may be implemented to be similar to or substantially the same as that described in FIG. 5, so a repeated description thereof may be omitted herein.

In an embodiment, if the execution result of the TA indicates execution success, the secure VM manager 600 may transfer the execution result of the TA to the application 411 to cause the application 411 to be executed.

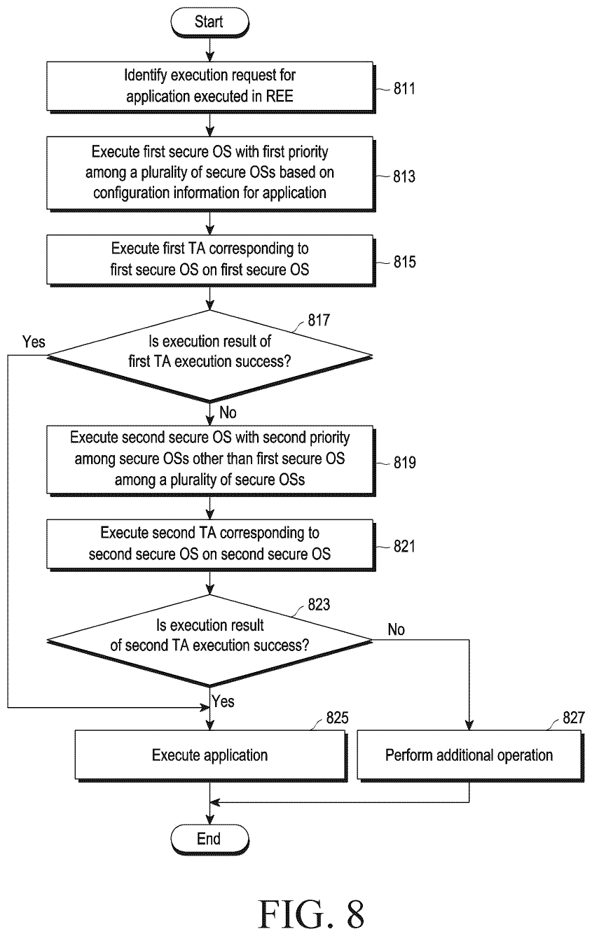

FIG. 8 is a flowchart illustrating an operating process of an electronic device according to an embodiment of the disclosure.

Referring to FIG. 8, an electronic device (e.g., an electronic device 101 in FIG. 1) (e.g., one or more processors including processing circuitry) (e.g., a processor 120 in FIG. 1) may, in operation 811, identify an execution request for an application (e.g., an application 411 in FIG. 4, 5, 6, or 7) executed in an REE. In an embodiment, the REE may correspond to a non-secure mode, a non-secure zone, or a normal zone.

The electronic device which identifies the execution request for the application may, in operation 813, execute a first secure OS with a first priority among a plurality of secure OSs based on configuration information for the application which includes priorities of a plurality of secure OSs on which a plurality of TAs related to the application are executable. In an embodiment, the first priority may indicate the highest priority among the priorities of the plurality of secure OSs. The configuration information for the application may be implemented to be similar to or substantially the same as that described in FIG. 5, so a repeated description thereof may be omitted herein.

The electronic device which executes the first secure OS may, in operation 815, execute a first TA corresponding to the first secure OS among a plurality of TAs on the first secure OS.

The electronic device which executes the first TA may, in operation 817, identify whether an execution result of the first TA is execution success.

As a result of the identification, if the execution result of the first TA is execution failure (Operation 817—No), the electronic device may, in operation 819, execute a second secure OS with a second priority among secure OSs other than the first secure OS among the plurality of secure OSs. In an embodiment, based on the execution result of the first TA being the execution failure, the electronic device may identify a secure OS with a priority immediately following the first priority among the plurality of secure OSs, identify whether the identified secure OS is installed in the electronic device, and based on the identified secure OS being installed in the electronic device, set the identified secure OS as the second secure OS. In an embodiment, based on the identified secure OS not being installed in the electronic device, the electronic device may identify a secure OS with the highest priority among the remaining secure OSs, excluding the first secure OS and the identified secure OS, among the plurality of secure OSs, identify whether the secure OS with the highest priority among the remaining secure OSs is installed in the electronic device, and based on the secure OS with the highest priority among the remaining secure OSs being installed in the electronic device, set the secure OS with the highest priority among the remaining secure OSs as the second secure OS.

The electronic device which executes the second secure OS may, in operation 821, execute a second TA corresponding to the second secure OS among the plurality of TAs on the second secure OS.

The electronic device which executes the second TA may, in operation 823, identify whether an execution result of the second TA is execution success.

As a result of the identification, if the execution result of the second TA is the execution success (Operation 823—Yes), the electronic device may execute the application in operation 825.

As the result of the identification, if the execution result of the first TA is the execution success (Operation 817—Yes), the electronic device may proceed to operation 825 to execute the application.

As the result of the identification, if the execution result of the second TA is execution failure (Operation 823—No), the electronic device may perform an additional operation in operation 827. The additional operation in operation 827 may be described as follows.

If the execution result of the second TA is execution failure, the electronic device may execute a third secure OS with a third priority among secure OSs other than the first secure OS and the second secure OS among the plurality of secure OSs, execute a third TA corresponding to the third secure OS among the plurality of TAs on the third secure OS, and based on an execution result of the third TA being execution success, execute the application.

Although not separately illustrated in FIG. 8, based on identifying that the application is not executed after a set number of secure OSs among the plurality of secure OSs are executed based on the priorities of the plurality of secure OSs, the electronic device may refrain from executing the application and provide information indicating that the application failed to be executed.

Although not separately illustrated in FIG. 8, based on identifying that the application is not executed after at least some of the plurality of secure OSs are executed during set time based on the priorities of the plurality of secure OSs, the electronic device may refrain from executing the application and provide information indicating that the application failed to be executed.

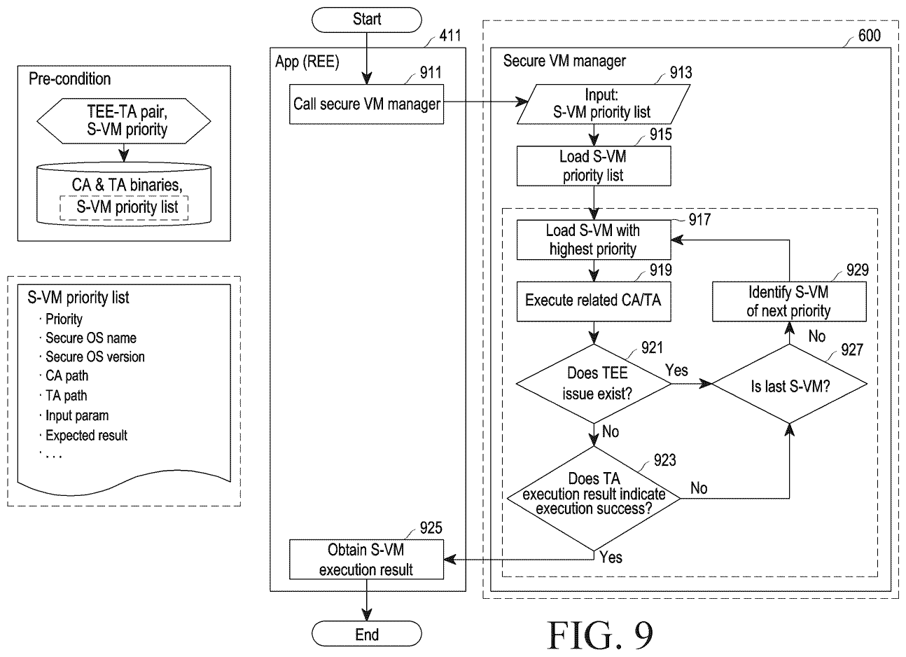

FIG. 9 is a diagram for explaining an operation of executing a TA in a TEE supporting a plurality of secure OSs according to an embodiment of the disclosure.

Referring to FIG. 9, an operation of executing a TA in a TEE supporting a plurality of secure OSs described in FIG. 9 may differ in that a secure VM manager (e.g., a secure VM manager 511 in FIG. 5) and a secure VM controller (e.g., a secure VM controller 513 in FIG. 5) are implemented in a form of an integrated secure VM manager 600 (e.g., a secure VM manager 600 in FIG. 6 or 7) compared to an operation of executing a TA in a TEE supporting a plurality of secure OSs described in FIG. 5.

As described in FIG. 5, as an execution request for an application 411 (e.g., an application 411 in FIG. 4, 5, or 6) is identified in an REE (or a non-secure mode, a non-secure zone, or a normal zone), the application 411 may transfer a TA execution request for requesting execution of a TA related to the application 411 to the secure VM manager 600. The secure VM manager 600 in FIG. 9 may be a module in which the secure VM manager and the secure VM controller described in FIG. 5 are integrated. In an embodiment, the TA execution request may include configuration information (or a configuration file) including information about a plurality of secure OSs on which a plurality of TAs related to the application 411 are executable. In FIG. 9, configuration information for the application 411 is represented as an S-VM priority list.

Meanwhile, in FIG. 9, Pre-condition may include parameters which may be considered when the application 411 is developed or when the configuration information for the application 411 is generated. In an embodiment, Pre-condition may include a TEE-TA pair, an S-VM priority, CA & TA binaries, and/or an S-VM priority list.

In an embodiment, the TEE-TA pair may include TAs which may be executed (e.g., may be supported) in the application 411 and information related to a TEE which will execute each of TAs which may be executed in the application 411 (e.g., information related to a secure OS or an S-VM).

In an embodiment, the S-VM priority may indicate a priority of TEEs (e.g., a secure OS or an S-VM) generated based on pieces of TEE information identified when considering the TEE-TA pair. In an embodiment, the S-VM priority may be generated considering pieces of information, e.g., a related CA, TA, and/or secure OS binary, required to execute the S-VM.

In an embodiment, the CA & TA binaries may include required CA and TA binaries identified while generating the S-VM priority. In an embodiment, the required CA and TA binaries identified while generating the S-VM priority may be installed in the electronic device upon release of the application 411 or before the release of the application 411. In an embodiment, the CA & TA binaries may include CA and TA binaries for each of a plurality of secure OSs supportable in the application 411.

In another embodiment, the S-VM priority list may be installed in the electronic device upon the release of the application 411 or before the release of the application 411. The S-VM priority list may correspond to the configuration information for the application 411.

As the execution request for the application 411 is identified in the REE, in operation 911, the application 411 may call the secure VM manager 600. In an embodiment, a call operation in operation 911 may correspond to a TA execution request operation for requesting the execution of the TA related to the application 411.

In operation 913, the configuration information for the application 411 may be inputted to the secure VM manager 600 called from the application 411 through the call operation of the application 411.

The secure VM manager 600 to which the configuration information for the application 411 is inputted may, in operation 915, load the S-VM priority list.

The secure VM manager 600 which loads the S-VM priority list may, in operation 917, load an S-VM with the highest priority based on the S-VM priority list.

The secure VM manager 600 which loads the S-VM with the highest priority may execute a CA and a TA related to the corresponding S-VM in operation 919. In an embodiment, the secure VM manager 600 may execute the CA and the TA related to the corresponding S-VM based on information included in the S-VM priority list.

The secure VM manager 600 which executes the CA and the TA related to the corresponding S-VM may identify whether a TEE-related issue exists in operation 921. In an embodiment, the TEE-related issue may include an issue in which the secure OS is abnormally terminated due to a serious error such as TEE_Panic. TEE_Panic has been described in FIG. 4, so a repeated description thereof may be omitted herein.

If the TEE-related issue does not exist, the secure VM manager 600 may, in operation 923, identify whether an execution result of the TA is execution success.

If the execution result of the TA is the execution success, the secure VM manager 600 may transfer the execution result for the corresponding S-VM to the application 411, and therefore the application 411 may obtain the execution result for the corresponding S-VM.

As a result of the identification in operation 921, if the TEE-related issue exists, the secure VM manager 600 may identify whether the corresponding S-VM is the last S-VM on the S-VM priority list in operation 927.

If the S-VM is not the last S-VM on the S-VM priority list, the secure VM manager 600 may identify an S-VM corresponding to the next priority in operation 929 and return to operation 917 to perform an operation related to the identified S-VM.

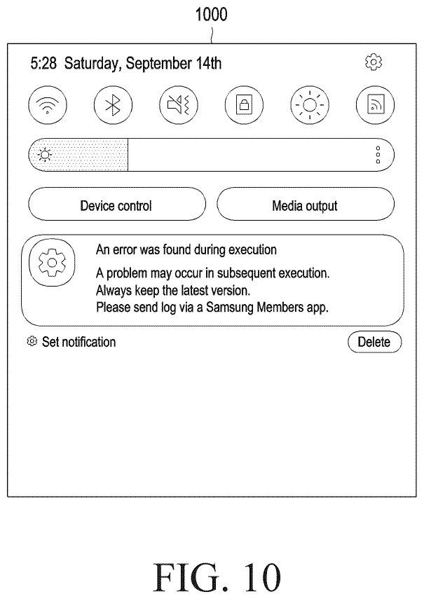

FIG. 10 is a diagram illustrating a user interface of an electronic device which executes a TA in a TEE supporting a plurality of secure OSs according to an embodiment of the disclosure.

Referring to FIG. 10, a screen 1000 may be a screen provided (e.g., outputted) if an electronic device (e.g., an electronic device 101 in FIG. 1) (e.g., a smart phone) fails to execute an application (e.g., an application 411 in FIG. 4, 5, 6, 7, or 9).

There may not be a user interface which requires a user of an electronic device to directly manipulate, depending on an operation of the electronic device which executes a TA in a TEE which supports a plurality of secure OSs as described in FIGS. 5 to 9. However, if execution of an application fails due to failure in the execution of the TA, failure in the execution of the application may be prevented by providing information indicating that an error has occurred (e.g., “An error was found during execution.”) and information inducing an update to the latest software (e.g., “A problem may occur in subsequent execution. Always keep the latest version. Please send log via a Samsung Members app.”), as in the screen 1000.

According to an embodiment of the disclosure, a method of an electronic device (101) may comprise identifying an execution request for an application in a rich execution environment (REE).

According to an embodiment of the disclosure, the method may comprise, based on the execution request for the application, executing a first secure operating system (OS) with a first priority among a plurality of secure OSs, based on configuration information for the application including priorities of the plurality of secure OSs in which a plurality of trusted applications (TAs) related to the application are executable.

According to an embodiment of the disclosure, the method may comprise executing, on the first secure OS, a first TA corresponding to the first secure OS among the plurality of TAs.

According to an embodiment of the disclosure, the method may comprise, based on an execution result of the first TA being execution failure, executing a second secure OS with a second priority among secure OSs other than the first secure OS among the plurality of secure OSs.

According to an embodiment of the disclosure, the method may comprise executing, on the second secure OS, a second TA corresponding to the second secure OS among the plurality of TAs.

According to an embodiment of the disclosure, the method may comprise, based on an execution result of the second TA being execution success, executing the application.

According to an embodiment of the disclosure, a TA may include an application being executed in a trusted execution environment (TEE).

The plurality of secure OSs may be executed in the TEE.

According to an embodiment of the disclosure, the configuration information for the application may include locations where the plurality of TAs are stored on the plurality of secure OSs, locations where client applications (CAs) which communicate with the plurality of TAs in the REE are stored, names of the plurality of secure OSs, and versions of the plurality of secure OSs.

According to an embodiment of the disclosure, the configuration information for the application may include input parameters for the plurality of TAs, and expected output values for the plurality of TAs.

According to an embodiment of the disclosure, the method may comprise, based on an execution result of the second TA being execution failure, executing a third secure OS with a third priority among secure OSs other than the first secure OS and the second secure OS among the plurality of secure OSs.

According to an embodiment of the disclosure, the method may comprise executing, on the third secure OS, a third TA corresponding to the third secure OS among the plurality of TAs.

According to an embodiment of the disclosure, the method may comprise, based on an execution result of the third TA being execution success, executing the application.

According to an embodiment of the disclosure, the TEE may be distinguished from the REE.

According to an embodiment of the disclosure, the TEE may be used for protecting an authentication mechanism.

According to an embodiment of the disclosure, one or more non-transitory computer-readable storage media storing one or more computer programs including computer-executable instructions that, when executed by one or more processors of an electronic device individually or collectively, cause the electronic device to perform operations may be provided. According to an embodiment of the disclosure, the operations may comprise identifying an execution request for an application in a rich execution environment (REE).

According to an embodiment of the disclosure, the operations may comprise, based on the execution request for the application, executing a first secure operating system (OS) with a first priority among a plurality of secure OSs, based on configuration information for the application including priorities of the plurality of secure OSs in which a plurality of trusted applications (TAs) related to the application are executable.

According to an embodiment of the disclosure, the operations may comprise executing, on the first secure OS, a first TA corresponding to the first secure OS among the plurality of Tas.

According to an embodiment of the disclosure, the operations may comprise, based on an execution result of the first TA being execution failure, executing a second secure OS with a second priority among secure OSs other than the first secure OS among the plurality of secure OSs.

According to an embodiment of the disclosure, the operations may comprise executing, on the second secure OS, a second TA corresponding to the second secure OS among the plurality of Tas.

According to an embodiment of the disclosure, the operations may comprise, based on an execution result of the second TA being execution success, executing the application.

According to an embodiment of the disclosure, a TA may include an application being executed in a trusted execution environment (TEE).

According to an embodiment of the disclosure, the plurality of secure OSs may be executed in the TEE.

According to an embodiment of the disclosure, the configuration information for the application may include locations where the plurality of TAs are stored on the plurality of secure OSs, locations where client applications (CAs) which communicate with the plurality of TAs in the REE are stored, names of the plurality of secure OSs, and versions of the plurality of secure OSs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to a particular embodiment and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory comprising one or more storage media, storing instructions; and
one or more processors communicatively coupled to the memory,
wherein the instructions that, when executed by the one or more processors individually or collectively, cause the electronic device to:
identify an execution request for an application in a rich execution environment (REE),
based on the execution request for the application, execute a first secure operating system (OS) with a first priority among a plurality of secure OSs, based on configuration information for the application including priorities of the plurality of secure OSs in which a plurality of trusted applications (TAs) related to the application are executable,
execute, on the first secure OS, a first TA corresponding to the first secure OS among the plurality of TAs,
based on an execution result of the first TA being execution failure, execute a second secure OS with a second priority among secure OSs other than the first secure OS among the plurality of secure OSs,
execute, on the second secure OS, a second TA corresponding to the second secure OS among the plurality of TAs, and
based on an execution result of the second TA being execution success, execute the application,
wherein a TA includes an application being executed in a trusted execution environment (TEE), and
wherein the plurality of secure OSs are executed in the TEE.

2. The electronic device of claim 1, wherein the configuration information for the application includes:
locations where the plurality of TAs are stored on the plurality of secure OSs;
locations where client applications (CAs) which communicate with the plurality of TAs in the REE are stored;
names of the plurality of secure OSs; and
versions of the plurality of secure OSs.

3. The electronic device of claim 2, wherein the configuration information for the application includes:
input parameters for the plurality of TAs; and
expected output values for the plurality of TAs.

4. The electronic device of claim 3, wherein the instructions, when executed by the one or more processors individually or collectively, further cause the electronic device to:
based on an execution result of the second TA being execution failure, execute a third secure OS with a third priority among secure OSs other than the first secure OS and the second secure OS among the plurality of secure OSs;
execute, on the third secure OS, a third TA corresponding to the third secure OS among the plurality of TAs; and
based on an execution result of the third TA being execution success, execute the application.

5. The electronic device of claim 4, wherein the instructions, when executed by the one or more processors individually or collectively, further cause the electronic device to:
as at least part of, based on the execution result of the first TA being the execution failure, executing the second secure OS:
based on the execution result of the first TA being the execution failure, identify a secure OS with a priority immediately following the first priority among the plurality of secure OSs;
identify whether the identified secure OS is installed in the electronic device; and
based on the identified secure OS being installed in the electronic device, set the identified secure OS as the second secure OS.

6. The electronic device of claim 5, wherein the instructions, when executed by the one or more processors individually or collectively, further cause the electronic device to:
as at least part of, based on the execution result of the first TA being the execution failure, executing the second secure OS:
based on the identified secure OS being not installed in the electronic device, identify a secure OS with a highest priority among remaining secure OSs other than the first secure OS and the identified secure OS among the plurality of secure OSs;
identify whether the secure OS with the highest priority among the remaining secure OSs is installed in the electronic device; and
based on the secure OS with the highest priority among the remaining secure OSs being installed in the electronic device, set the secure OS with the highest priority among the remaining secure OSs as the second secure OS.

7. The electronic device of claim 6, wherein the instructions, when executed by the one or more processors individually or collectively, further cause the electronic device to:
based on identifying that the application is not executed after executing a set number of secure OSs among the plurality of secure OSs based on the priorities of the plurality of secure OSs, refrain from executing the application; and
provide information indicating execution failure for the application.

8. The electronic device of claim 6, wherein the instructions, when executed by the one or more processors individually or collectively, further cause the electronic device to:
based on identifying that the application is not executed after executing at least part of the plurality of secure OSs based on the priorities of the plurality of secure OSs, refrain from executing the application; and
provide information indicating execution failure for the application.

9. One or more non-transitory computer-readable storage media storing one or more computer programs including computer-readable instruction that, when executed by one or more processors of an electronic device individually or collectively, cause the electronic device to perform operations, the operations comprising:
identifying an execution request for an application in a rich execution environment (REE);
based on the execution request for the application, executing a first secure operating system (OS) with a first priority among a plurality of secure OSs, based on configuration information for the application including priorities of the plurality of secure OSs in which a plurality of trusted applications (TAs) related to the application are executable;
executing, on the first secure OS, a first TA corresponding to the first secure OS among the plurality of TAs;
based on an execution result of the first TA being execution failure, executing a second secure OS with a second priority among secure OSs other than the first secure OS among the plurality of secure OSs;
executing, on the second secure OS, a second TA corresponding to the second secure OS among the plurality of TAs; and
based on an execution result of the second TA being execution success, executing the application,
wherein a TA includes an application being executed in a trusted execution environment (TEE), and
wherein the plurality of secure OSs are executed in the TEE.

10. The one or more non-transitory computer-readable storage media of claim 9, wherein the configuration information for the application includes:
locations where the plurality of TAs are stored on the plurality of secure OSs;
locations where client applications (CAs) which communicate with the plurality of TAs in the REE are stored;
names of the plurality of secure OSs; and
versions of the plurality of secure OSs.

11. The one or more non-transitory computer-readable storage media of claim 10, wherein the configuration information for the application includes:
input parameters for the plurality of TAs; and
expected output values for the plurality of TAs.

12. The one or more non-transitory computer-readable storage media of claim 11, the operations further comprising:
based on an execution result of the second TA being execution failure, executing a third secure OS with a third priority among secure OSs other than the first secure OS and the second secure OS among the plurality of secure OSs;
executing, on the third secure OS, a third TA corresponding to the third secure OS among the plurality of TAs; and
based on an execution result of the third TA being execution success, executing the application.

13. The one or more non-transitory computer-readable storage media of claim 12, wherein, based on the execution result of the first TA being the execution failure, executing the second secure OS comprises:
based on the execution result of the first TA being the execution failure, identifying a secure OS with a priority immediately following the first priority among the plurality of secure OSs;
identifying whether the identified secure OS is installed in the electronic device; and
based on the identified secure OS being installed in the electronic device, setting the identified secure OS as the second secure OS.

14. The one or more non-transitory computer-readable storage media of claim 12, wherein, based on the execution result of the first TA being the execution failure, executing the second secure OS comprises:
based on the identified secure OS being not installed in the electronic device, identifying a secure OS with a highest priority among remaining secure OSs other than the first secure OS and the identified secure OS among the plurality of secure OSs;
identifying whether the secure OS with the highest priority among the remaining secure OSs is installed in the electronic device; and
based on the secure OS with the highest priority among the remaining secure OSs being installed in the electronic device, setting the secure OS with the highest priority among the remaining secure OSs as the second secure OS.

15. The one or more non-transitory computer-readable storage media of claim 14, the operations further comprising:
based on identifying that the application is not executed after executing a set number of secure OSs among the plurality of secure OSs based on the priorities of the plurality of secure OSs, refraining from executing the application; and
providing information indicating execution failure for the application.

16. The one or more non-transitory computer-readable storage media of claim 14, the operations further comprising:
based on identifying that the application is not executed after executing at least part of the plurality of secure OSs based on the priorities of the plurality of secure OSs, refraining from executing the application; and
providing information indicating execution failure for the application.

17. A method of an electronic device, the method comprising:
identifying an execution request for an application in a rich execution environment (REE);
based on the execution request for the application, executing a first secure operating system (OS) with a first priority among a plurality of secure OSs, based on configuration information for the application including priorities of the plurality of secure OSs in which a plurality of trusted applications (TAs) related to the application are executable;
executing, on the first secure OS, a first TA corresponding to the first secure OS among the plurality of TAs;
based on an execution result of the first TA being execution failure, executing a second secure OS with a second priority among secure OSs other than the first secure OS among the plurality of secure OSs;
executing, on the second secure OS, a second TA corresponding to the second secure OS among the plurality of TAs; and
based on an execution result of the second TA being execution success, executing the application,
wherein a TA includes an application being executed in a trusted execution environment (TEE), and
wherein the plurality of secure OSs are executed in the TEE.

18. The method of claim 17, wherein the configuration information for the application includes:
locations where the plurality of TAs are stored on the plurality of secure OSs;
locations where client applications (CAs) which communicate with the plurality of TAs in the REE are stored;
names of the plurality of secure OSs; and
versions of the plurality of secure OSs.

19. The method of claim 18, wherein the configuration information for the application includes:
input parameters for the plurality of TAs; and
expected output values for the plurality of TAs.

20. The method of claim 19, comprising:
based on an execution result of the second TA being execution failure, executing a third secure OS with a third priority among secure OSs other than the first secure OS and the second secure OS among the plurality of secure OSs;
executing, on the third secure OS, a third TA corresponding to the third secure OS among the plurality of TAs; and
based on an execution result of the third TA being execution success, executing the application.
